(19) United States
(12) Patent Application Publication
(10) Pub. No.: US 2014/0205199 A1
(43) Pub. Date: Jul. 24, 2014

(54) Storage Area and Temporal Based Optimized Run Length Codec For Classic JPEG Image Compression (SAT-BORL CODEC)

(71) Applicants: Qamarul Islam, Islamabad (PK); Muhammad Bilal Akhtar, Islamabad (PK); Adil Masoud Qureshi, Rawalpindi (PK)

(72) Inventors: Qamarul Islam, Islamabad (PK); Muhammad Bilal Akhtar, Islamabad (PK); Adil Masoud Qureshi, Rawalpindi (PK)

(21) Appl. No.: 13/748,014

(22) Filed: Jan. 23, 2013

(51) Int. Cl. G06T 9/00

(52) U.S. Cl. CPC G06T 9/007
USPC 382/250

(57) ABSTRACT

This invention optimizes the entropy encoding part of JPEG (Joint Photographic Experts Group) image compression by modifying the run length encoding method that performs the actual compression by removing the redundancy from transformed and quantized image data. Using the fact that the preceding processes of run length coding, in JPEG compression algorithm, produces a large number of zeros, the original run length coding uses an ordered pair (a,b), where ‘a’ is the length of consecutive zeros preceding the ASCII character ‘b’. The proposed run length encoding scheme removes an unintended redundancy, from the original run length encoding scheme, by using an ordered pair only when a zero occurs and using the same EOB (End of Block) parameter at the end of each block. The proposed encoding scheme does not alter the value of PSNR but is found to be very effective in reducing the size of JPEG compressed image data.

### FIELD OF THE INVENTION

This invention presents an optimized Run Length Coding for Classic JPEG Image Compression.

### BACKGROUND OF THE INVENTION

JPEG is the most widely used standard for compressing still images. A step involved in JPEG compression converts an input image (2D) matrix into a sequence of data (1D) vector suitable for transmission and storage. This part is known as entropy encoding for JPEG image Compression that involves Run Length Coding, with some modifications that suits to JPEG Image compression. The standard JPEG document does not bind the user to stick to Run Length Coding, for its high inefficiency in some cases, to be used for Entropy Encoding.

For JPEG compression algorithm several people have optimized the various blocks of the compression technique. As in T. Agui Y. Arai and M. Nakajima. “A fast DCT-SQ Scheme for Images”. Transactions of the IEICE, E 71:1095-1097, November 1988 (hereinafter “reference [1]”) some work has been done to reduce the computational complexity of the first step in image compression, i.e. DCT (Discrete Cosine Transformation). In A. B. Watson, “Visual optimization of DCT quantization matrices for individual images,” in Proc AIAA, vol. 9, pp. 286-291, 1993 (hereinafter “reference [2]”) ways on optimizing the quantization matrix has been proposed making the compromise between image quality and image size an optimum. Some have proposed a joint optimization technique using Huffman coding in E. H. Yang and L. Wang, “Joint optimization of run-length coding, Huffman coding and quantization table with complete baseline JPEG decoder compatibility,” in Proc. ICIP 2007. vol. 3, pp. 181-184, September 2007 (hereinafter “reference [3]”).

A novel adaptive runlength coding approach has been followed in C. Tu, J. Liang, and T. D. Tran, “Adaptive runlength coding,” IEEE Signal Processing Letters, vol, 10, pp. 61-64, March 2003 (hereinafter “reference [4]”) where the proposed algorithm outperforms the conventional runlength coding scheme by a large margin but with an increase in the processing delay due to the adaptive nature of the modified algorithm. In reference [4] the modification has not been made to the Run Length Coding process instead it modifies Entropy Encoding Binarization, a step that is used after Run Length Coding. Therefore this technique in reference [4] can be used in conjunction to our technique for a highly optimized image compression system.

Simulation results have shown that using the optimized run length coding algorithm proposed in this patent has also temporally been very effective by reducing the processing time delay up to 50% in most of the cases, where in the past research in this field not much importance has been given to time efficiency of the coding technique.

The inventors are involved in the imaging payload design of CubeSat project, details on website http://www.ist.edu.pk/student satellite.html, which poses the challenges of limited size and time window over which the CubeSat communicates with the ground station. These constraints dictate the size of the images taken in space. For efficient use of limited memory size and sending the image data within the limited time window the image acquired in space needs to be compressed. The inventors have also made an IEEE conference paper of the invention M. B. Akhtar, A. M. Qureshi, Qamarul Islam, “Optimized Run length Coding for JPEG Image compression used in space research program of IST,” in Proc. ICCNIT 2011, pp. 81-85, July 2011 (hereinafter “reference [5]”).

### SUMMARY OF THE INVENTION

The technique addressed in this patent has optimized the Run Length Coding part of Classic JPEG Image Compression and has greatly reduced the compressed image size, the ultimate goal of any compression technique, for all the images tested increasing the efficiency of Run Length Coding.

Run length coding alone is used to compress ASCII character set by a pair of RUNS and LEVELS, where RUNS shows the number of consecutive LEVELS, the ASCII character in the ASCII character set.

In JPEG compression algorithm the run length coding is modified such that it only encodes the consecutive number of zeros, as the probability of occurrence of consecutive zeros is very high. The method counts the number of repeated zeros between two non-zero numbers and appends the non-zero number following the pattern of zeros. This way it adds redundancy in the encoded data for a series of consecutive non-zero numbers, when it was meant to compress the original data. The encoded message for a fixed coding scheme consists of an 8 bit value of RUN and an 8 bit signed value of LEVEL. This kind of scheme is called Byte-Level Run Length Coding.

The optimized RLC uses a pair of (RUN, LEVELS) only when a pattern of consecutive zeros occur at the input of the encoder. The non-zero digits are encoded as their respective values in LEVELS parameter. RUN parameter is eliminated from the final encoded message for the non-zero digits. This modification makes use of the following two observations:
1. Consecutively occurring zeros in the input data stream is very common.
2. Non-zero digits with same value occurring consecutively is a very rare case in classic JPEG Image compression.

The optimized run length coding algorithm does not amend the end of block (EOB) parameter and uses the same (0, 0) pair as the end of block. As illustrated in FIG. 2, an added Boolean variable ‘B’ 3, to the optimized run length encoding algorithm, is used to identify the presence of a zero or consecutively occurring zeros in the input data stream. Presence of continuous zero digits in the input data stream toggles the initialized value of variable ‘B’ once 11. The variable ‘B’ is reinitialized at the end of the continuous zero digits in the input data stream. For consecutively occurring zeros at the end of block the process to increment the value of RUN variable 10 is bypassed to the process of appending EOB 12 to the encoded message.

Simulations have proved that the optimized run length coding algorithm takes lesser time in processing than the original Run length ceding algorithm, making it temporally efficient as well. A greater reduction in size would also mean a greater reduction in propagation delay, for real time transmission scenarios.

### BRIEF DESCRIPTION OF THE DRAWINGS

FIG. 1 illustrates the steps involved in JPEG image compression where transformation used is Discrete Cosine Transform (DCT) while the compression block combines Run Length Encoding with Entropy Encoding.

FIG. 2 illustrates, in a flowchart, the steps involved in optimized Run Length Coding scheme.

### DETAIL DESCRIPTION OF PREFERRED EMBODIMENTS

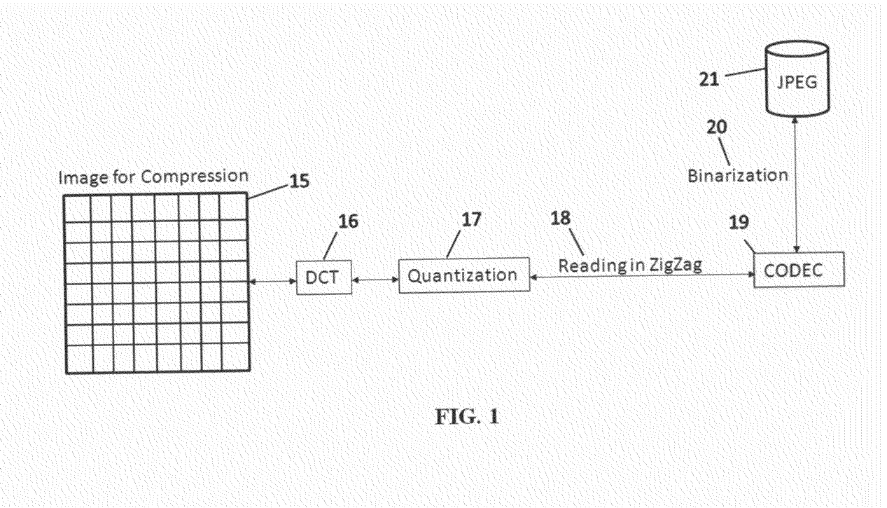

Referring to the drawings FIG. 1 illustrates the block diagram of the standard JPEG image compression technique used. It consists of dividing the image into blocks of 8×8 pixels 15, followed by Discrete Cosine Transform 16 and quantization process 17 applied on each block separately. The resultant matrix is read in a zigzag pattern 18 to produce large redundancy that is encoded by the run length coding process 19 and converted to machine language, in binary form through the process of binarization 20. The resultant bit format is stored as JPEG compressed image 21.

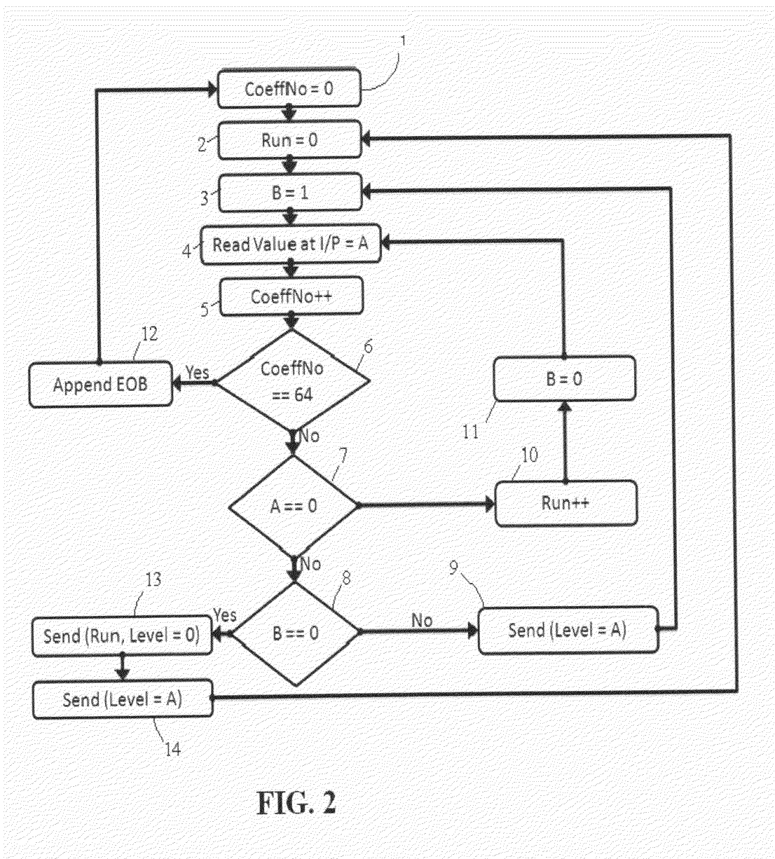

FIG. 2 illustrates the data flow diagram of the invention. The image data that has been transformed, quantized and read in a zigzag pattern is fed into the encoder one value at a time 4 read as variable A. The following variables are defined with functions as follows:
1. CoeffNo is used to identify the end of block 6 and is a counter that is incremented 5 every time after an entry is read in variable A. The value of CoeffNo is initialized to zero 1.
2. Run is used to count the numbers of zeros 10 that occur in the data read in the zigzag pattern. Its value is initialized to zero 2.
3. B is the Boolean variable that is initialized to the value of one 3 and used to break out of the loop 8 of incrementing the value of runs for consecutively occurring zeros. The value of Run is stored 13 till the next non-zero entry is read into variable A 14.

When no zero occurs 7 in the input data stream, the input value is encoded with value of level as the data in variable A 9. The Boolean variable 8 toggles from its initialized value 11 to zero whenever there is an occurrence of a single zero or consecutively occurring zeros in the input data stream. When the input data stream reaches its last entry of each 8×8 block it appends an ordered pair (0,0) as end of block to the encoded message 12.

### Technical Issues Addressed by the Invention

With recent advances in communication technology transmitting image data has become very common as news with picture on Television has become preferable than News on Radio. Increased load of communicating in pictorial/video data has put a high demand on efficient utilization of the limited resources used for the communication purposes e.g. memory space, bandwidth available and time for transmission. In this regards signal processing techniques, called Image Compression Techniques, have been developed to reduce the total size of an image ready for storage (offline processing) or transmission (real-time processing).

Run Length Coding plays a very important role in compressing (reducing the size required for storage) an image. This invention uses an optimized scheme for entropy encoding part of JPEG image compression by modifying the run length encoding method. In JPEG (Joint Photographic Experts Group) image compression algorithm run length coding performs the actual compression by removing the redundancy from transformed and quantized image data. It was observed that the original Run Length Coding would add to the redundancy of the image data and in most cases produced a compressed image that exceeded in total size than the raw image data size. Both the colored and grayscale images have been used for testing. Original Run Length Coding produced good results mostly for grayscale images and images with high level of correlation.

The proposed encoding scheme does not alter the PSNR value for the algorithm. But to get the same PSNR values the optimized RLC method produced highly compressed data than the original RLC method. Using Matlab simulation, the proposed scheme has been tested on various images over a range of quantization (quality) factor and the results confirmed the effectiveness of the new run length encoding scheme in significantly reducing the run length encoded data size with reduced processing time delay.

### Intended Use of the Invention

This optimized approach to Run Length Coding for JPEG image Compression algorithm has got very useful application in the fields of:
1. Satellite Communication: e.g., Remote Sensing Satellite, Imaging Amateur Satellites;
2. Digital Communication: e.g., DSNG, Television Broadcasting, Internet; and,
3. others: e.g., Efficient Camera Technology, Unmanned Aerial Vehicle, Image Database management, Biometrics.

After applying the invention on various images it was concluded that the optimized Run Length coding helped save a huge amount of memory size over a range of quantization factor values. In most cases it has reduced the data, amount up to 50% of the memory used to store the un-optimized compressed image data. In some cases a Zero quantization factor, which means lossless compression, using optimized algorithm gives the best result compared with quantization factor of 10 used with original run length coding scheme. The optimized run length coding scheme has shown to reduce the size of compressed image, when used instead of classical run length coding scheme in lossy JPEG Compression algorithm with a considerable reduction in processing time delay.

The optimized algorithm can be easily varied for use in any other compression algorithm that uses Zero Run Length Coding algorithm before final binarization of the compressed image, like MPEG. All these variations can be made to the invention sticking to the claims defined below

What is claimed is:

1. A method for optimizing JPEG compression comprising:
a. applying a discrete cosine transform, as a transformation process to reveal the amount of redundancy in the image being compressed;
b. applying a quantization block, which serves to increase the number of zero values in the transformed matrix;
c. reading the quantized block into a row vector to produce large redundancy, using a zigzag reading pattern followed by a highly optimized run length coding algorithm to encode the redundancy; and,
d. applying a binarization process on the resulting row vector making it machine readable.

2. The method for optimizing JPEG compression according to claim 1, wherein raw data are processed prior to applying compression comprising:
a. transforming the colored image from RGB plane to YCbCr plane and applying the steps for compression, as defined in claim 1, separately on each plane;
b. dividing the prepared image into matrices of 8×8; and,
c. reading the blocks of 8×8 matrix from left to right and top to bottom, and applying the compression steps a-b as defined in claim 1 on each block of 8×8 separately.

3. The method for optimizing JPEG compression according to claim 1, wherein the quantization block used in step b of claim 1 and encoding its values for the whole image in the resultant compressed image data.

4. The method for optimizing JPEG compression according to claim 1, wherein the step d comprises a run length encoder applied to the resultant row vector in the following steps:
a. encode a non-zero number with a single byte as levels using an ordered pair for encoding on the occurrence of a single zero or consecutively occurring zeros in the row vector to be encoded; and,
b. setting the value of level to zero when a single zero or consecutively occurring zeros occur.

5. The method for optimizing JPEG compression according to claim 2, wherein the step b occurs up to the end of the row vector formed by an 8×8 block encoding end of block with runs as zero and levels as zero.

6. The method for optimizing JPEG compression according to claim 3, wherein the quantization block is extracted prior to decompressing the said JPEG compressed image data.

7. The method for extracting image from data produced through compression of the image according to claim 1 wherein the order of steps from a to d is reversed to d to a.
